(19) United States
(12) Patent Application Publication
(10) Pub. No.: US 2011/0085203 A1
(43) Pub. Date: Apr. 14, 2011

(54) PRINTING APPARATUS, PRINTING SYSTEM AND PROGRAM FOR PRINTING

(75) Inventor: Shinji Ohira, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/899,687

(22) Filed: Oct. 7, 2010

Related U.S. Application Data
(60) Provisional application No. 61/249,666, filed on Oct. 8, 2009.

(51) Int. Cl. G06F 15/00

(52) U.S. Cl. 358/1.15

(57) ABSTRACT

A printing apparatus includes a communication section to receive print data, a storage section to store an address of another printing apparatus that holds the same print data as the print data, and a first control section to transmit first information, which indicates that the print data is already printed, to the another printing apparatus through the communication section. The first information may be a signal to instruct the another printing apparatus to delete the print data or a signal to notify a user that the print data is already printed.

### CROSS-REFERENCE TO RELATED APPLICATION

This application is based upon and claims the benefit of priority from: U.S. provisional application 61/249,666, filed on Oct. 8, 2009, the entire contents of each of which are incorporated herein by reference.

### FIELD

Embodiments described herein relate generally to a technique to control storage of print data.

### BACKGROUND

There is a printing system having a function in which print data is simultaneously transmitted to plural printing apparatuses from a host computer. In this type of printing system, the transmitted print data is temporarily stored in the respective printing apparatuses, and the user performs an operation of releasing the print data stored in the respective printing apparatuses, so that printing is performed.

However, even when printing is performed in one printing apparatus, the print data remains stored in another printing apparatus, and therefore, there is a fear that the print data is wastefully stored. Besides, when the unnecessary print data remains in the printing apparatus, there is a problem in security.

### DESCRIPTION OF THE DRAWINGS

FIG. 1 is a system view showing a structure of a printing system of an embodiment.

FIG. 2 is a sectional view of a printing apparatus.

FIG. 3 is a data table showing identification information of print data and an addresses of another printing apparatus.

FIG. 4 is a flowchart showing a procedure when it is broadcast that distributed printing was performed.

FIG. 5 is a flowchart showing a procedure when distributed data is deleted.

### DETAILED DESCRIPTION

According to an embodiment, in general, a printing apparatus includes a communication section to receive print data, a storage section to store an address of another printing apparatus that holds the same print data as the print data, and a controller to transmit first information, which indicates that the print data is already printed, to the another printing apparatus through the communication section.

According to another embodiment, in general, a printing system includes a first printing apparatus including a first storage section to store first print data, a second printing apparatus including a communication section to receive the first print data, a second storage section to store the first print data and an address of the first printing apparatus, and a controller to transmit first information, which indicates that the first print data is already printed, to the first printing apparatus through the communication section, and a client terminal to transmit the first print data to the first and the second printing apparatuses.

### First Embodiment

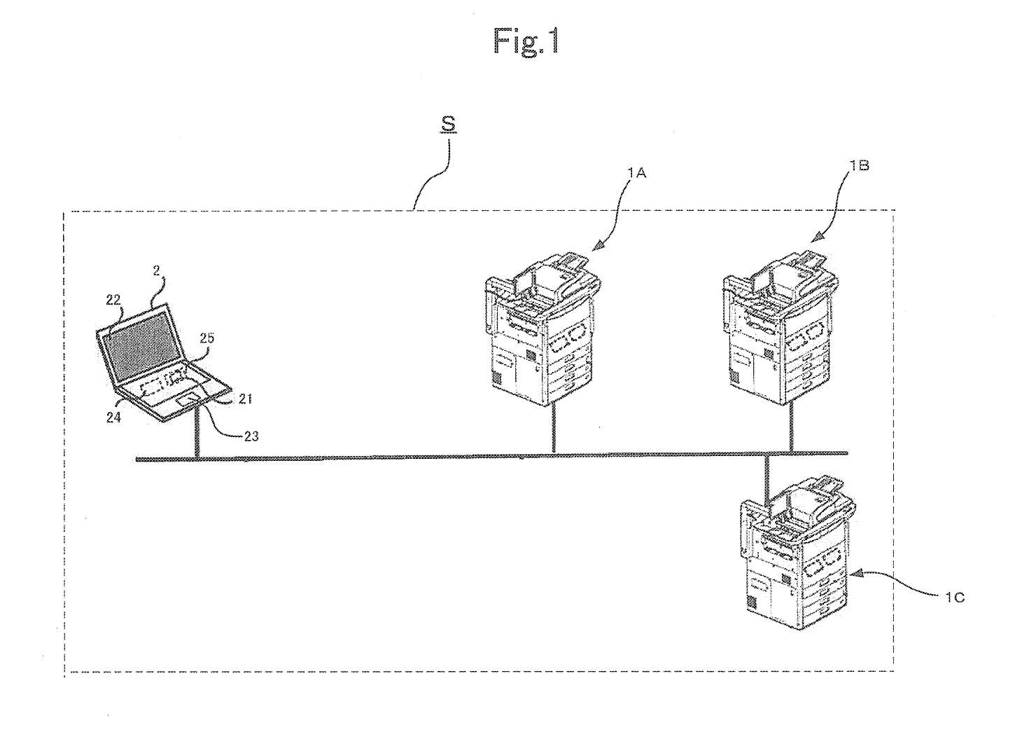

FIG. 1 is a system view showing a structure of a printing system of an embodiment.

A printing system S includes a host computer 2 as a client terminal and plural printing apparatuses 1A to 1C. In the following description, when it is not necessary to distinguish between the printing apparatuses 1A to 1C, each of them is represented as a printing apparatus 1. The host computer 2 and the printing apparatuses 1A to 1C are mutually connected through a network such as a LAN (Local Area Network) or a WAN (Wide Area Network).

The host computer 2 includes an operation section 21, a display section 22, a communication section 23, a storage section 24 and a PC controller 25.

The operation section 21 includes a keyboard, a mouse, a touch panel, a touchpad or a graphics tablet.

The display section 22 may be an LCD (Liquid Crystal Display), an EL (Electronic Luminescence), a PDP (Plasma Display Panel) or a CRT (Cathode Ray Tube). The operation section 21 and the display section 22 may be integrally realized by a touch panel.

The PC controller 25 uses an application for printing and transmits print data to the respective printing apparatuses 1A to 1C through the communication section 23. The communication section 23 may transmit the print data to the respective printing apparatuses 1A to 1C through a not-shown print job management server.

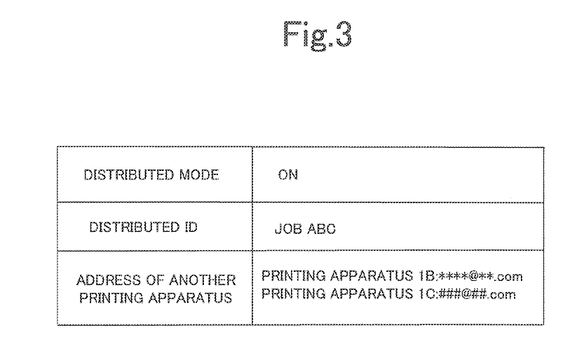

The communication section 23 of the host computer 2 may transmit, together with the print data, identification information of the print data and an address of another printing apparatus. FIG. 3 is a data table showing identification information of print data and an address of another printing apparatus.

A distributed mode is a format of a print mode, and “ON” indicates that a print application is executed in the distributed mode. A distributed ID indicates a job name of distributed print data printed in the distributed mode. An address indicates an address of another printing apparatus to which the distributed print data is transmitted.

In the example illustrated in FIG. 3, the host computer 2 transmits the distributed print data with the distributed ID of “job ABC” to the printing apparatuses 1A to 1C. The transmission system may be an SNMP (Simple Network Management Protocol).

With reference to FIG. 1, the storage section 24 may be a RAM (Random Access Memory), a ROM (Read Only Memory), a DRAM (Dynamic Random Access Memory), an SRAM (Static Random Access Memory) or a VRAM (Video RAM). The storage section 24 stores various information and programs used in the host computer 2.

The PC controller 25 may be a CPU (Central Processing Unit). The PC controller 25 executes programs stored in the storage section 24 and realizes various functions.

The host computer 2 has a first mode (normal print mode) in which print data is transmitted to one of the printing apparatuses 1A to 1C, and a second mode (distributed printing mode) in which print data is simultaneously transmitted to all the printing apparatuses 1A to 1C.

The PC controller 25 executes a print application, and sets the print mode to the first mode or the second mode based on information inputted through the operation section 21.

In the first mode, the PC controller 25 transmits the print data to one printing apparatus 1 through the communication section 23.

The user may previously specify the one printing apparatus 1. The PC controller 25 may specify the one printing apparatus 1 according to the use frequency. The user may specify the one printing apparatus 1 by operating the operation section 21 when the print application is executed and printing is performed.

In the second mode, the PC controller 25 transmits the same print data, that is, the distributed print data to the plural printing apparatuses 1 from the communication section 23. Identification information to identify the distributed print data may be added to the distributed print data. The user may previously specify the plural printing apparatuses 1. The PC controller 25 may specify the plural printing apparatuses 1 according to the use frequency. The user may specify the plural printing apparatuses 1 through the operation section 21 when the print application is executed and printing is performed. The plural printing apparatuses 1 may be all printing apparatuses connected through the network. When the distributed print data is transmitted to all the printing apparatuses connected through the network, this saves the user from having to select the printing apparatuses.

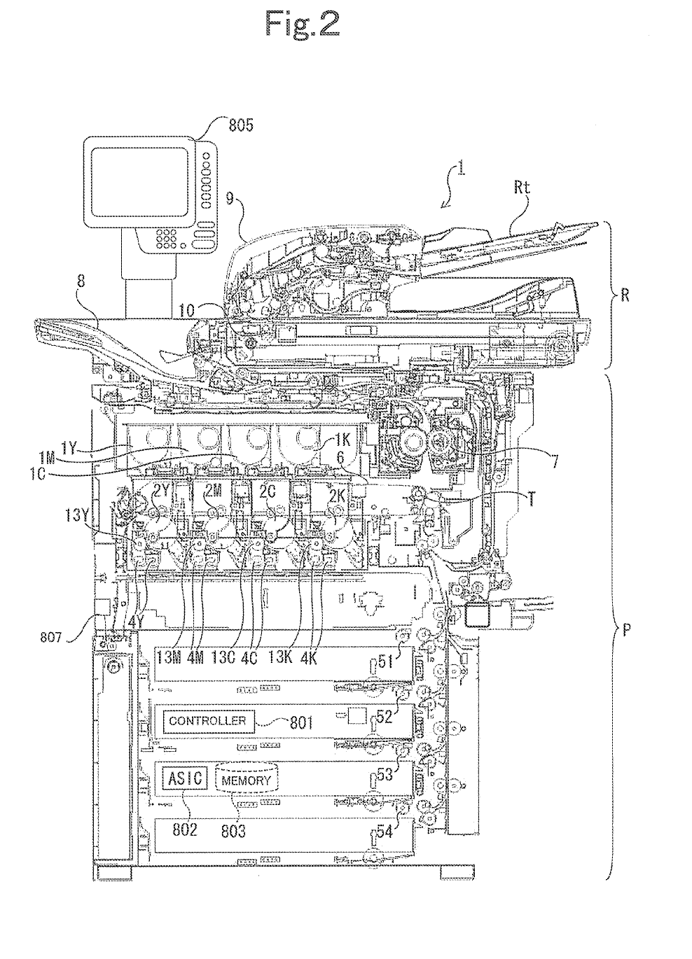

FIG. 2 is a sectional view of the printing apparatus. The printing apparatus 1 may be an MFP (Multi Function Printer).

With reference to FIG. 2, the printing apparatus 1 includes an image reading section R and an image forming section P. The image reading section R scans and reads an image of a sheet document and a book document.

The image forming section P forms a developer image on a sheet based on the image read from the document by the image reading section R or print data transmitted from an external equipment to the printing apparatus 1.

The image reading section R includes an auto document feeder (ADF) 9 to automatically feed a document to a specified image read position, and reads an image of a document placed on a document tray (specified document placing table) Rt, which is automatically fed by the auto document feeder 9, or an image of a document placed on a not-shown document table by a scanning optical system 10.

The image forming section P includes toner cartridges 1Y to 1K, pickup rollers 51 to 54, photoreceptors 2Y to 2K, development rollers 13Y to 13K, mixers 4Y to 4K, an intermediate transfer belt 6, a fixing device 7 and a discharge tray 8.

Besides, the printing apparatus 1 of the embodiment includes a controller 801, an ASIC circuit 802, a memory 803, an operation display section 805 and a communication section 807.

The controller 801 serves to perform various processes in the printing apparatus 1, and serves to realize various functions by executing programs stored in the memory 803. The memory 803 may be, for example, a RAM (Random Access Memory), a ROM (Read Only Memory), a DRAM (Dynamic Random Access Memory), an SRAM (Static Random Access Memory) or a VRAM (Video RAM), and serves to store various information and programs used in the printing apparatus 1.

The memory 803 stores distributed print data transmitted from the host computer 2 through the network, identification information of the distributed print data, and an address of another printing apparatus.

The operation display section 805 displays various settings. The operation display section 805 may be an LCD (Liquid Crystal Display), an EL (Electronic Luminescence), a PDP (Plasma Display Panel) or a CRT (Cathode Ray Tube).

The various settings are changed by operating the operation display section 805. The operation display section 805 may be of a touch panel type.

The communication section 807 receives various information including print data transmitted from the host computer 2.

Hereinafter, the outline of printing will be described as an example of processes performed in the printing apparatus of the embodiment.

First, a sheet picked up from a cassette by the pickup rollers 51 to 54 enters a sheet conveyance path. The sheet supplied into the sheet conveyance path is moved toward a specified conveying direction by plural roller pairs.

The scanning optical system 10 reads images of plural sheet documents continuously automatically conveyed by the auto document feeder 9 at the specified image read position.

Next, electrostatic latent images are formed on photosensitive surfaces of the photoreceptors 2Y, 2M, 2C and 2K for transferring to a sheet based on the print data of the image read from the document by the image reading section R.

Next, developers agitated by the mixers 4Y to 4K in developing units are supplied by the developing rollers 13Y to 13K to the photoreceptors 2Y to 2K on which the electrostatic latent images are formed. By this, the electrostatic latent images formed on the photosensitive surfaces of the photoreceptors are visualized.

The developer images formed on the photoreceptors are transferred (so-called primary transfer) onto a belt surface of the intermediate transfer belt 6, and the developer images conveyed by the rotation of the intermediate transfer belt are transferred onto the conveyed sheet at a specified secondary transfer position T.

The developer images transferred on the sheet are heated and fixed to the sheet by the fixing unit 7. The sheet on which the developer images are heated and fixed is conveyed in the conveyance path by plural conveyance roller pairs, and is sequentially discharged onto the discharge tray 8.

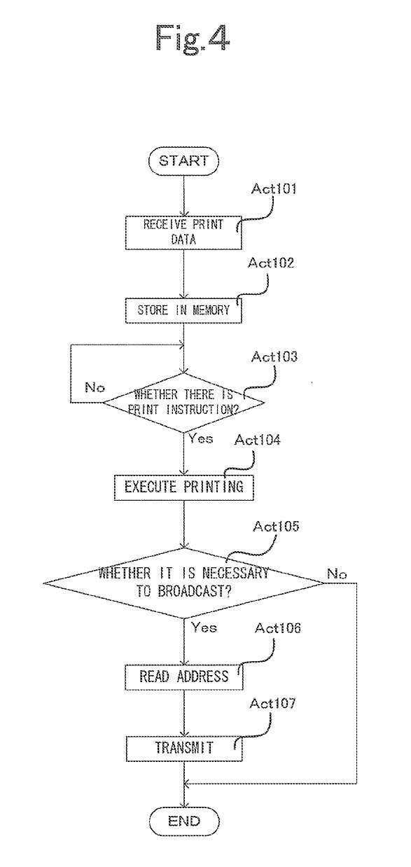

FIG. 4 is a flowchart showing a procedure when it is notified to another printing apparatus that distributed printing was performed in one printing apparatus. In the flowchart, the one printing apparatus is the printing apparatus 1A, and the another printing apparatus is the printing apparatuses 1B to 1C.

At Act 101, the communication section 807 of the printing apparatus 1A receives print data transmitted from the host computer 2. At Act 102, the controller 801 of the printing apparatus 1A stores the received print data in the memory 803.

At Act 103, the controller 801 of the printing apparatus 1A determines through the operation of the operation display section 805 whether a printing operation is instructed.

At Act 103, when the printing operation is instructed, at Act 104, the controller 801 of the printing apparatus 1A instructs the image forming section P to perform the printing operation.

At Act 105, the controller 801 determines whether it is necessary to notify the another printing apparatus that printing was executed. Specifically, when information corresponding to the data table shown in FIG. 3 is attached to the print data, the controller 801 specifies the another printing apparatus having the same distributed data from the information. In the example shown in FIG. 3, the printing apparatuses 1B to 1C hold the same distributed data.

At Act 105, when it is determined that the information corresponding to the data table shown in FIG. 3 is not attached to the print data, this flow is ended.

At Act 106, the controller 801 of the printing apparatus 1A reads the addresses of the printing apparatuses 1B to 1C from the data table, and at Act 107, the controller outputs, to the printing apparatuses 1B to 1C, a delete signal to instruct deletion of the same distributed print data as the distributed print data printed by the printing apparatus 1A. The delete signal includes distributed ID information to specify the deleted distributed print data.

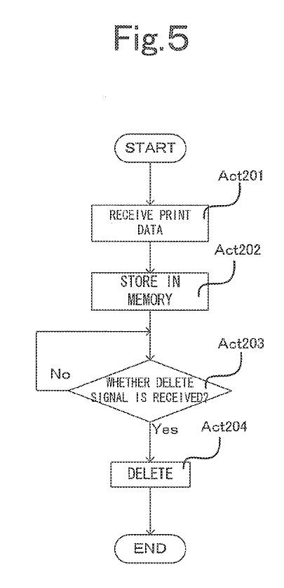

FIG. 5 is a flowchart showing a procedure when the printing apparatus 1B deletes the distributed print data. At Act 201, the controller 801 of the printing apparatus 1B receives the distributed print data. At Act 202, the controller 801 of the printing apparatus 1B stores the received distributed print data in the memory 803.

At Act 203, the controller 801 of the printing apparatus 1B determines whether the signal to delete the distributed print data is received. At Act 204, the controller 801 of the printing apparatus 1B deletes the distributed print data stored in the memory 803.

The printing apparatus 1C deletes the distributed print data in the same method as that for the printing apparatus 1B.

The controller 801 executes a program for printing stored in the memory 803 and notifies the another printing apparatus that the printing operation is completed.

In this embodiment, although the description is made on the case where the program for printing is previously stored in the storage area provided in the printing apparatus 1, no limitation is made to this. The same program may be downloaded from a network to the printing apparatus 1, or a computer readable recording medium storing the same program may be installed in the printing apparatus 1. The recording medium may have any form as long as the recording medium can store the program and can be read by the computer. Specifically, as the recording medium, for example, an internal storage device, such as a ROM or RAM, installed in the computer, a portable storage medium such as a CD-ROM, a flexible disk, a DVD disk, a magneto-optical disk or an IC card, a database to hold the computer program or another computer and its database, a transmission medium on a line and the like can be enumerated. Besides, the function previously obtained by installation or download as stated above may realize the function in cooperation with the OS (Operating System) of the apparatus.

Incidentally, a part of or the entire of the program may be a dynamically generated execution module.

Besides, it is needless to say that at least a part of various processes realized by executing the program by the controller 801 in the embodiment can be executed by a circuit in the ASIC 802.

### Modified Example 1

In the foregoing embodiment, although the method of acquiring an address of another printing apparatus is the method of adding the address of the another printing apparatus to the distributed print data, another method may be adopted. The another method may be a method of previously registering an address list of printing apparatuses within a sub-network in memories of the respective printing apparatuses.

When the distributed printing is completed, the printing apparatus reads the address list from the memory, and outputs a delete signal to delete the distributed'print data to another printing apparatus. The delete signal includes distributed ID information to specify the deleted distributed print data. When the another printing apparatus does not hold the distributed print data, the another printing apparatus neglects the delete signal.

### Modified Example 2

In the foregoing embodiment, although the printing apparatus 1 which performed the printing operation outputs the delete signal to delete the distributed print data, another method may be adopted. The another method may be such a method that the printing apparatus 1 which performed the printing operation merely notifies another printing apparatus of the completion of the printing operation. The printing apparatus 1 which receives the completion signal may display, on the operation display section 805, the job name of the distributed print data and information indicating that the printing of the job is completed.

Based on the information displayed on the operation display section 805, the user deletes the distributed print data or may leave the distributed print data in the inside of the image forming apparatus 1 without deleting the distributed print data.

### Modified Example 3

When distributed print data is printed, an input screen for requesting input of authentication information may be displayed on the operation display section 805. Unless the user inputs the authentication information corresponding to the transmitted distributed data, printing is not performed. It is prevented that the distributed print data is deleted in another printing apparatus without user's instruction. Authentication information held by a person having right to perform printing is added to the distributed print data. When authentication information coincident with this authentication information is inputted through the operation display section 805, the printing operation is allowed.

The invention can be carried out in various forms without departing from the sprit or the principal feature thereof. Thus, the foregoing embodiments are merely exemplary in any points, and should not be interpreted restrictedly. The scope of the invention is defined by the claims, and is not restricted by the contents of the specification. Further, all modifications, various improvements, substitutions and alterations belonging to the equivalent range of the claims are within the scope of the invention.

What is claimed is:

1. A printing apparatus comprising:
a communication section to receive print data;
a storage section to store an address of another printing apparatus that holds the same print data as the print data; and
a controller to transmit first information, which indicates that the print data is already printed, to the another printing apparatus through the communication section.

2. The apparatus of claim 1, wherein the first information is a signal to instruct the another printing apparatus to delete the print data.

3. The apparatus of claim 1, wherein the first information is a signal to notify a user that the print data is already printed.

4. The apparatus of claim 1, wherein the print data received by the communication section is added with identification information of the data.

5. The apparatus of claim 4, wherein
the print data received by the communication section is added with the address of the another printing apparatus, and
the controller stores the address of the another printing apparatus in the storage section.

6. The apparatus of claim 4, wherein the address of the another printing apparatus is previously stored in the storage section before the print data is received.

7. The apparatus of claim 1, further comprising an operation section to operate the apparatus, wherein
the controller allows printing of the print data only when authentication information is inputted through the operation section.

8. The apparatus of claim 7, wherein the print data received by the communication section is added with information corresponding to the authentication information.

9. A printing system comprising:
a fist printing apparatus including a first storage section to store first print data;
a second printing apparatus including a communication section to receive the first print data, a second storage section to store the first print data and an address of the first printing apparatus, and a controller to transmit first information, which indicates that the first print data is already printed, to the first printing apparatus through the communication section; and
a client terminal to transmit the first print data to the first and the second printing apparatuses.

10. The system of claim 9, wherein the first information is a signal to instruct the first printing apparatus to delete the first print data.

11. The system of claim 9, wherein the first information is a signal to notify a user that the first print data is already printed.

12. The system of claim 9, wherein the first print data received by the communication section is added with identification information of the data.

13. The system of claim 12, wherein
the first print data received by the communication section is added with the address of the first printing apparatus, and
the controller stores the address of the first printing apparatus in the second storage section.

14. The system of claim 12, wherein
the second printing apparatus includes an operation section, and
the address of the first printing apparatus is previously stored in the second storage section before the second printing apparatus receives the print data.

15. The system of claim 9, wherein
the second printing apparatus includes an operation section, and
the controller allows printing of the first print data only when authentication information is inputted through the operation section.

16. A program for printing of a printing apparatus to cause a computer to execute processes of:
printing print data received by a communication section;
determining whether the received print data is distributed print data transmitted also to another printing apparatus; and
transmitting first information indicating that printing is completed to the another printing apparatus through the communication section when, the received print data is the distributed print data.

17. The program of claim 16, wherein the first information is a signal to instruct the another printing apparatus to delete the print data.

18. The program of claim 16, wherein the first information is a signal to notify a user that the print data is already printed.

19. The program of claim 16, wherein the print data received by the communication section is added with identification information of the data.

20. The program of claim 19, wherein the printing apparatus includes a storage section storing an address of the another printing apparatus.
